(19) United States
(12) Patent Application Publication
(10) Pub. No.: US 2016/0202829 A1
(43) Pub. Date: Jul. 14, 2016

(54) METHOD FOR DRIVING TOUCH SCREEN PANEL AND TOUCH SCREEN PANEL EMPLOYING THE METHOD

(71) Applicant: Samsung Display Co., Ltd., Yongin-si (KR)

(72) Inventors: Sang Min Choi, Hwaseong-si (KR); Ji Hong Park, Suwon-si (KR); Moon Sung Choi, Incheon (KR)

(21) Appl. No.: 14/843,681

(22) Filed: Sep. 2, 2015

(30) Foreign Application Priority Data
Jan. 13, 2015 (KR) 10-2015-0006286

(51) Int. Cl. G06F 3/041; G06F 3/044

(52) U.S. Cl. CPC G06F 3/0416; G06F 3/044

(57) ABSTRACT

A touch screen panel includes: a plurality of touch electrodes formed, in matrix, on a display panel including a plurality of pixels including a common electrode to which common voltage is supplied and a touch driver distinguishing the plurality of touch electrodes to apply sensing driving signals having different polarities.

### CROSS REFERENCE TO RELATED APPLICATION

This application claims priority from and the benefit of Korean Patent Application No. 10-2015-0006286, filed on Jan. 13, 2015, which is hereby incorporated by reference for all purposes as if fully set forth herein.

### BACKGROUND

1. Field

Exemplary embodiments relate to a method for driving a touch screen panel, and particularly, to a method for driving a touch screen panel that may reduce noise.

2. Discussion of the Background

Display devices such as liquid crystal displays (LCD), organic light emitting diode (OLED) displays, and electrophoretic displays typically include a field generating electrode and an electro-optical active layer. For example, the OLED display includes an organic emission layer as the electro-optical active layer. The field generating electrode may be connected to a switching element such as a thin film transistor to receive a data signal. The electro-optical active layer may convert the data signal into an optical signal to display an image.

A display device including touch sensing, which allows a user to interact with the display in addition to simply displaying an image, has been recently developed. The touch sensing may determine contact information, such as whether an object contacts or approaches a screen and a contact position thereof, by sensing a change in pressure, charge, light, and the like which may be applied onto the screen in the display device when the user writes or draws on the screen by contacting or approaching the screen with a finger or a touch pen. The display device may receive an image signal based on the contact information to display an image.

The touch sensing may be implemented using a touch sensor. The touch sensor may be classified according to type, such as a resistive type, a capacitive type, an electromagnetic (EM) type, and an optical type.

The capacitive type touch sensor may include a sensing capacitor including a plurality of sensing electrodes that may transfer a sensing signal and may determine whether a touch exists or a touch location by sensing a change in charged capacitance or a change in the amount of charge on the sensing capacitor, which occurs when a conductor such as a finger approaches the touch sensor.

Recently, a display device incorporating a touch sensor has been actively developed.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a method for driving a touch screen panel that may prevent image quality errors and deterioration of touch sensitivity.

Additional features of the invention will be set forth in the description which follows, and in part will be apparent from the description, or may be learned by practice of the invention.

An exemplary embodiment discloses a touch screen panel, including: a plurality of touch electrodes formed, in a matrix, on a display panel including a plurality of pixels including a common electrode to which common voltage is supplied; and a touch driver distinguishing the plurality of touch electrodes to apply sensing driving signals having different polarities.

An exemplary embodiment also discloses a method for driving a touch screen panel including a plurality of touch electrodes formed, in a matrix, on a display panel including a plurality of pixels including a common electrode to which common voltage is supplied and a touch driver distinguishing the plurality of touch electrodes to apply sensing driving signals having different polarities, including: applying the sensing driving signals having different polarities by distinguishing the plurality of touch electrodes in one frame; and receiving sensing output signals output from the plurality of touch electrodes in the one frame.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating a display device according to an exemplary embodiment.

FIG. 2 is a diagram illustrating a pixel layout of a display panel illustrated in FIG. 1.

FIG. 3 is a block diagram of a touch screen panel according to an exemplary embodiment.

FIG. 4 is a cross-sectional view of a display device incorporating a touch screen panel according to an exemplary embodiment.

FIG. 5 is a diagram illustrating a method for driving a touch screen panel according to an exemplary embodiment.

FIG. 6 is a diagram illustrating a method for driving a touch screen panel according to another exemplary embodiment.

FIGS. 7A, 7B, 8A, 8B, 9A, 9B, 10A, 10B, 11A, and 11B are diagrams illustrating a method for driving a touch screen panel according to various exemplary embodiments.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. As such, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

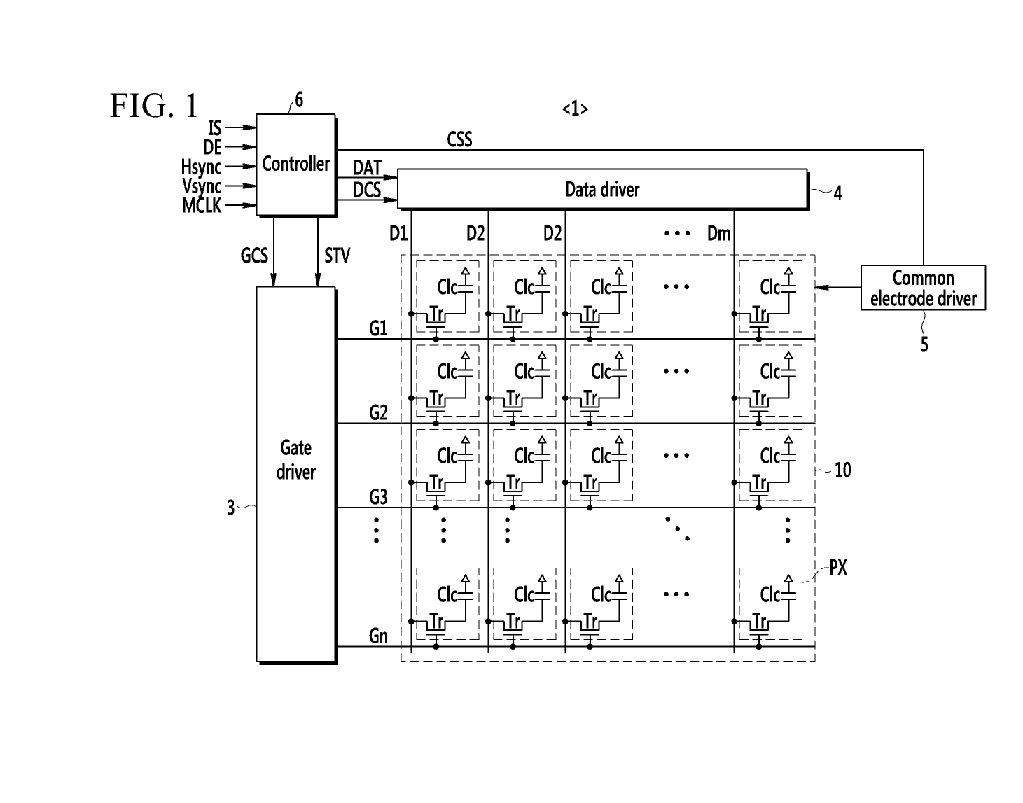

FIG. 1 is a block diagram illustrating a display device according to an exemplary embodiment.

Referring to FIG. 1, the display device 100 according to an exemplary embodiment may be one of various display devices including a liquid crystal display (LCD), an organic light emitting diode display (OLED) display, an electrophoretic display, an electrowetting display (EWD), or a display device using a microelectromechanical system (MEMS).

The display device according to the exemplary embodiment shown in FIG. 1 includes a display panel 10 displaying an image, a gate driver 3 and a data driver 4 connected thereto, a backlight unit (not illustrated) supplying light to the display panel 10, and a timing controller 6 controlling the gate driver 5, the data driver 4, and the backlight unit.

The display panel 10 includes a plurality of display signal lines and a plurality of pixels PX connected thereto. The plurality of pixels PXs may be arranged in a matrix form. The display signal line includes a plurality of gate lines G1 to Gn transferring a gate signal (also referred to as “scanning signal”) and a plurality of data lines D1 to Dm transferring data voltage. Each pixel PX may include a switching element Tr, such as thin film transistor, connected to the corresponding gate lines G1 to Gn and data lines D1 to Dm, and a liquid crystal capacitor (C1c) and a storage capacitor (Cst) connected thereto.

The liquid crystal capacitor Clc charges to a voltage difference between a data signal supplied to a pixel electrode through a switching element Tr and common voltage Vcom supplied to the pixels via a common electrode and drives liquid crystals according to the charged voltage to control light transmittance. The storage capacitor Cst stably stores the voltage charged in the liquid crystal capacitor Clc.

Hereinafter, in addition to an electrode to which the common voltage Vcom is applied, any electrodes serving as common electrodes in the display device 100 will be referred to as “common electrode”. Alternate voltage, DC voltage, or voltage of a form alternated at random frequencies applied to the common electrode of the display device 100 will be referred to as “common voltage”.

The display panel 10 may further include an electro-optical active layer that may display an image by converting data voltage applied to a pixel electrode into an optical signal. For example, the liquid crystal display may include a liquid crystal layer as the electro-optical active layer. Hereinafter, it will be described assumed that the display device in exemplary embodiments is a liquid crystal display, however, it will be appreciated that other display types may be used.

The timing controller 6 controls operations of the gate driver 3, the data driver 4, and a common electrode driver 5, and the like.

The timing controller 6 may receive an input image signal IS and an input control signal from an external source. The input image signal IS may include luminance information for each pixel PX of a display unit 10. Luminance information for the display device may be divided into a predetermined number of gray levels, for example, 1024, 256, or 64 grays. The input control signal may include a vertical synchronization signal Vsync, a horizontal synchronization signal Hsync, a main clock MCLK, a data enable signal DE, and the like in association with the image display.

The timing controller 6 may appropriately process the input image signal IS according to an operational condition of the display panel 10. The operational condition of the display panel 10 may be based on the input image signal IS and the input control signal. From these inputs, the timing controller 6 may generate a data control signal DCS, a gate control signal GCS, a vertical synchronization start signal STV, and a digital image signal DAT.

The data control signal DCS may include a horizontal synchronization start signal, a clock signal, a polarity inversion signal, and a line latch signal. The gate control signal GCS may include an output enable signal and a gate pulse signal.

The timing controller 6 may output the gate control signal GCS to the gate driver 3 and output the data control signal DCS and a processed image signal DAT to the data driver 4.

The data driver 4 may divide a gray reference voltage received from a gray voltage generator (not illustrated) in accordance with the data lines D1 to Dm of the display panel 10 and may generate gray voltages for all grays, or may receive a plurality of gray voltages from the gray voltage generator.

The data driver 4 receives a digital image signal DAT for one row of pixels PX according to the data control signal DCS and may select the gray voltage corresponding to each digital image signal DAT from the gray voltages to convert the digital image signal DAT into the data voltage. Thereafter, the data driver 4 may apply the converted data voltage to the corresponding data lines D1 to Dm.

The gate driver 3 is connected to the gate lines G1 to Gn to apply a gate signal including a gate-on voltage and a gate-off voltage to the gate lines G1 to Gn.

The gate driver 3 may apply the gate-on voltage to the gate lines G1 to Gn according to the gate control signal GCS from the timing controller 6 to turn on the switching element Tr connected to the gate lines G1 to Gn. Then, the data voltage applied to the data lines D1 to Dm may be applied to the corresponding pixel PX through the switching element Tr, which is turned on.

The backlight unit (not illustrated) may be positioned in the rear of the display panel 10 and may include at least one light source. Examples of the light source may include a fluorescent lamp such as a cold cathode fluorescent lamp (CCFL), a light emitting diode (LED), and the like. The light source included in the backlight unit (not illustrated) may be turned on or off for a predetermined time. The backlight unit (not illustrated) may further include at least one linear light guide plate facing the display panel 10.

The display panel 10 applies the gate-on voltage to all gate lines G1 to Gn by the unit of 1 horizontal period (also referred to as “1H”, the same as one period of the horizontal synchronization signal and the data enable signal) and applies the data voltage to all pixels PX to display the image. Hereinafter, it will be assumed for the sake of clarity and simplicity that one horizontal period is one frame.

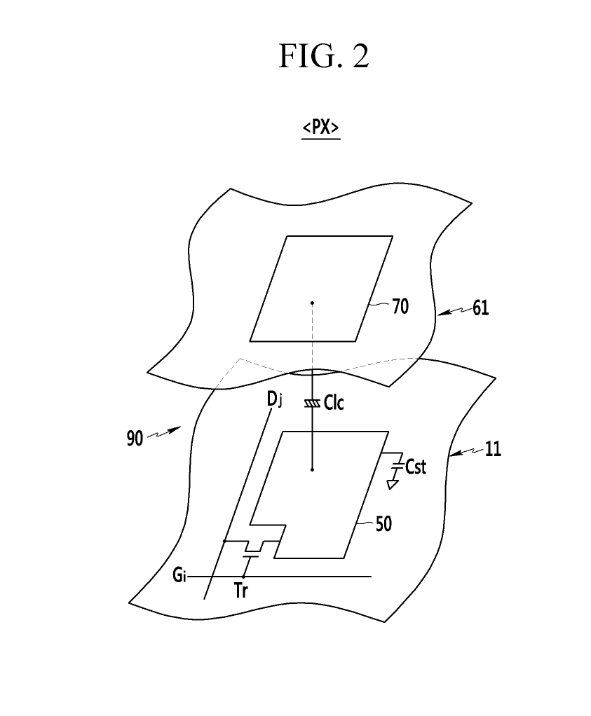

Next, referring to FIG. 2, a structure of the pixels PX deployed on the display panel 10 will be described.

FIG. 2 is a diagram illustrating the pixels PX of the display panel 10 illustrated in FIG. 1. As illustrated in FIG. 2, the display device 10 may have a configuration in which a first substrate 11 and a second substrate 61 which face and are bonded to each other with a liquid crystal layer 90.

Gate lines G1 to Gn and data lines D1 to Dm vertically and horizontally cross on the top of the first substrate 11.

Transistors Tr are provided at cross points of the gate lines G1 to Gn and the data lines D1 to Dm. The transistors Tr are connected to gate lines G1 to Gn and the data lines D1 to Dm and correspond to pixel electrodes 50 formed at the respective pixels PX.

As shown in FIG. 2, the pixel PX connected to an i-th gate line Gi and a j-th data line Dj may include a transistor Tr connected to the i-th gate line Gi and the j-th data line Dj. The pixel electrode 50 is connected to the transistor Tr, and a liquid crystal capacitor (C1c) and a storage capacitor (Cst) may be positioned between the pixel electrode 50 and the common electrode. In some embodiments, the transistor Cst may be omitted.

The liquid crystal capacitor Clc may use the pixel electrode 50 and the common electrode 70 of the second substrate 61 as two terminals and the liquid crystal layer 90 between two electrodes 50 and 70 may serve as a dielectric.

The common electrode 70 may be made of a transparent conductive material, but may be made of another conductive material, such as opaque metal, or the like. For example, the common electrode 70 may be made of ITO (Indium Tin Oxide), IZO (Indium Zinc Oxide), graphene, carbon nanotubes, AgNWs (Silver Nanowires), and/or the like.

In FIG. 2, it is illustrated that the common electrode 70 is positioned on the second substrate 61; however, embodiments are not limited thereto. For example, the common electrode 70 may be positioned on the first substrate 11. In this case, the common electrode 70 may be formed on the same layer as the pixel electrode 50 or a different layer from the pixel electrode 50 according to a liquid crystal mode.

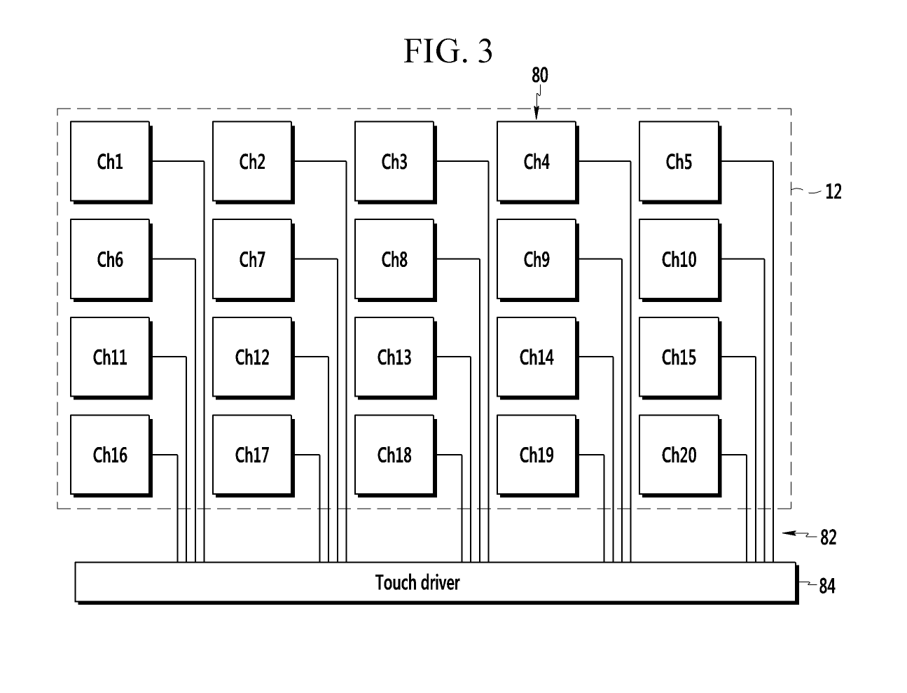

Next, a touch screen panel included in the display device 100 will be described with reference to FIG. 3.

FIG. 3 is a block diagram of a touch screen panel according to an exemplary embodiment. As illustrated in FIG. 3, the touch screen panel includes a touch sensor that may sense a touch location when the touch screen panel is touched or approached by an external object. The touch screen panel may use the same substrate as the display panel 10 and be formed on the top of the display panel 10, however, exemplary embodiments are not limited thereto. For example, the touch screen panel may be a structure in which the touch sensor is formed on a separate touch screen panel and attached to the display panel 10.

The touch sensor may be positioned in a touch region 12 corresponding to a display region of the display panel 10.

The touch sensor may include various types of touch sensors. For example, a plurality of touch sensors may include capacitive type touch sensors. The touch sensor may include a plurality of touch electrodes (not illustrated) formed on at least one layer.

The touch electrode may include thin conductive materials including indium tin oxide (ITO), indium zinc oxide (IZO), metal nanowire, a conductive polymer, a metal mesh, a thin metal layer, and the like.

When the touch sensor is a capacitive type touch sensor, the touch electrode 80 of the touch sensor receives a sensing driving signal from a touch driver 84 and generates a sensing output signal that varies depending on a touch to transmit the generated sensing output signal to the touch driver 84.

When the touch electrode 80 forms a self-sensing capacitor with the external object, the touch electrode 80 is charged with a predetermined charge amount by receiving the sensing driving signal. When an external object, such as a finger, etc., touches or approaches the touch region, the charge amount of the self-sensing capacitor is changed. As a result, the sensing output signal, which has a different charge than the received sensing driving signal, may be output to the touch driver 84. Touch information, such as occurrence of the touch, the touch location, and the like, may be determined by the change of the sensing output signal.

When the touch electrodes 80 adjacent to each other form a mutual-sensing capacitor, one touch electrode 80 is charged with a predetermined amount of charge by receiving the sensing driving signal from the touch driver 84. Thereafter, when the external objects, such as the finger, etc., touch or approach the touch region, the charge amount of the mutual-sensing capacitor is changed. As a result, the changed charge amount may be output as the sensing output signal. The touch information such as the occurrence of the touch, the touch location, and the like may be determined by the change of the sensing output signal.

The touch electrodes 80 may be positioned on the same layer or different layers as each other. Further, if the touch electrodes 80 are positioned on different layers they may be positioned on different planes around one substrate or on different layers on the same plane of the substrate.

The plurality of touch electrodes 80 may be connected to the touch driver 84 through a plurality of touch lines 82. Each touch line 82 may input a driving signal in the touch electrode 80 or output an output signal to the touch driver 84.

The touch line 82 may be positioned on the same layer as the touch electrode 80 or may be positioned on a different layer as the touch electrode 80. The touch line 82 may be formed with the same material as the touch electrode 80 in the same process as the touch electrode 80 or may be formed with a different material from the touch electrode 80.

The touch line 82 may be connected to a touch driver 84 that is not positioned in a peripheral region, but positioned in a lower end of the touch region 12 by extending vertically in the touch region 12.

The touch electrode 80 according to an exemplary embodiment is charged with a predetermined amount of charge by receiving the sensing driving signal through the touch line 82. Thereafter, when the external objects such as a finger, etc., contact the touch electrode 80, the charge amount of the self-sensing capacitor is changed. As a result, the sensing output signal may be different from the received sensing input signal. The touch information such as the occurrence of the touch, the touch location, and the like, may be determined by the change of the sensing output signal.

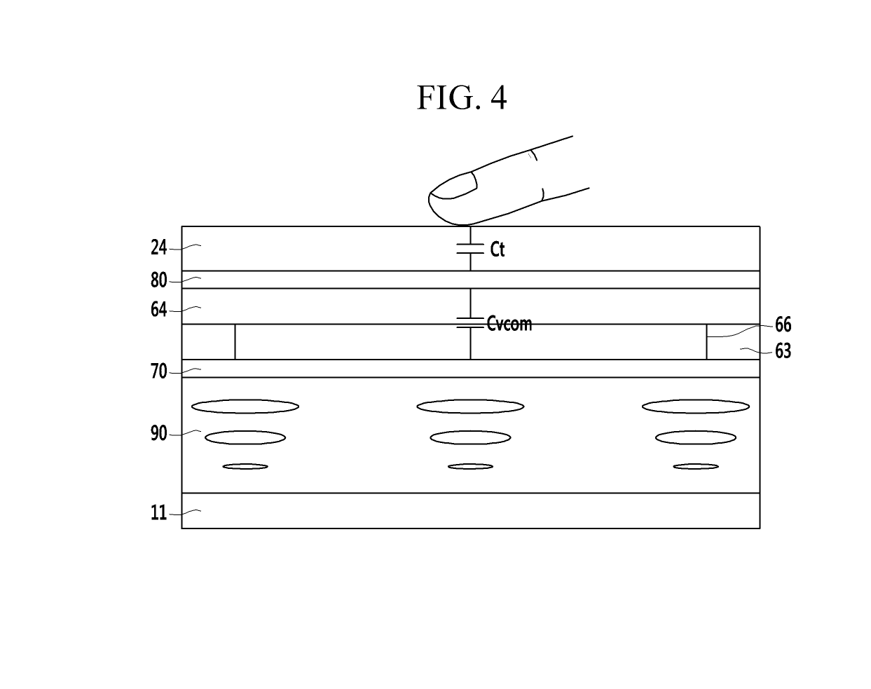

Next, structures of the display panel 10 and the touch screen panel will be described with reference to FIG. 4.

FIG. 4 is a cross-sectional view of a display device incorporated with a touch screen panel according to an exemplary embodiment. As illustrated in FIG. 4, a liquid crystal layer 90 is formed between the first substrate 11 and a second substrate 64 and the common electrode 70 is formed on the top of the liquid crystal layer 90.

A lattice-shaped black matrix 63 may be formed on a rear surface of the second substrate 64, and surrounds each pixel (PX) region so as to cover non-display regions such as the gate lines G1 to Gn, the data lines D1 to Dm, and the transistor Tr.

Further, a color filter pattern 66 corresponding to each pixel PX may be disposed in the black matrix 63, and the common electrode 70 may be disposed below the color filter pattern 66.

In this case, the color filter pattern 66 may include red, green, and blue color filter patterns (R, G, B) repeatedly arranged in sequence.

An overcoat layer (not illustrated) may be formed between the color filter pattern 66 and the common electrode 70.

In certain embodiments, the locations of the black matrix 63 and the color filter pattern 66 may vary based on use. Thus, when the black matrix 63 and the color filter pattern 66 are formed at different locations, the common electrode 70 may be formed on an inner surface of the second substrate 64.

In FIG. 4, the common electrode 70 is illustrated as positioned on the second substrate 64, but the common electrode 70 may be positioned on the first substrate 11. In this case, the common electrode 70 may be formed on the same layer as the pixel (PX) electrode or a different layer from the pixel (PX) electrode according to a liquid crystal mode.

The touch electrode 80 may be formed on the second substrate 64. The touch electrode 80 may be patterned in various ways. For example, the touch electrode 80 may be formed in dot matrix in which isolated islands are arranged in matrix or in a form in which linear patterns cross each other vertically and horizontally in the touch screen panel.

A cover window 24 may be formed on the touch electrode 80. The cover window 24 may be made of an insulating material such as plastic or glass. The cover window 24 may be flexible or rigid. The surface of the cover window 24 may be a touch plane of the display device which may be touched by external objects.

When, for example, the human finger approaches the touch electrode 80 at the cover window 24, touch capacitance Ct is formed between the finger and the touch electrode 80.

A capacitor Cvcom of the common electrode 70 is a capacitance formed when the touch electrode 80 faces the common electrode 70 of the display device, one side is connected to the touch driver 84 and common voltage is applied to the other side. The touch electrode 80 may generate the touch capacitance Ct together with a touch object, such as the finger. Further, the touch electrode 80 may form the capacitor Cvcom of the common electrode 70 with the color filter pattern 66 interposed therebetween.

During touch screen panel driving, signals from the common electrode 70 may be coupled with the sensing driving signal applied to the touch electrode 80, and as a result, noise may be generated in the common voltage.

Accordingly, a method for driving the touch screen panel that may reduce noise generated in the common voltage will be described below.

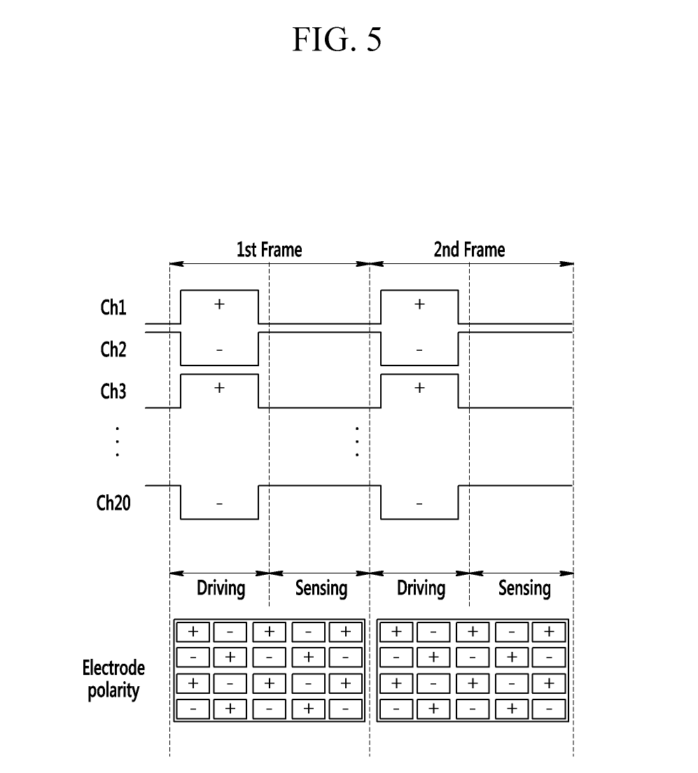

FIG. 5 is a diagram illustrating a method for driving a touch screen panel according to an exemplary embodiment. As illustrated in FIG. 5, the touch driver 84 may output the sensing driving signal to the plurality of touch electrodes 80. The touch driver 84 may also receive the sensing output signal output from the touch electrode 80 when external objects such as a finger, etc. touch the touch region or the external objects approach the touch region.

During a driving period in a frame, the touch driver 84 may output the touch driving signal. During a sensing period, the touch driver 84 may receive the sensing output signal.

The touch driver 84 may output the sensing driving signal so that the sum of polarities of the sensing driving signals output to the plurality of touch electrodes 80 is substantially 0 during one frame.

For example, in the first frame shown in FIG. 5, the touch driver 84 may output a positive sensing driving signal to odd-numbered touch electrodes Ch1, Ch3, Ch5, . . . , Ch19 and a negative sensing driving signal to even-numbered touch electrodes Ch2, Ch4, Ch6, . . . , Ch20.

In a second frame after the first frame, the touch driver 84 may output the positive sensing driving signal to the odd-numbered touch electrodes Ch1, Ch3, Ch5, . . . , Ch19 and the negative sensing driving signal to the even-numbered touch electrodes Ch2, Ch4, Ch6, . . . , Ch20.

Then, since the number of touch electrodes 80 to which the positive sensing driving signal is applied and the number of touch electrodes 80 to which the negative sensing driving signal is applied are the same as each other in one frame, a coupling potential of the touch driving signal and the common electrode 70 is substantially 0, and as a result, common voltage noise of the touch driving signal may be reduced.

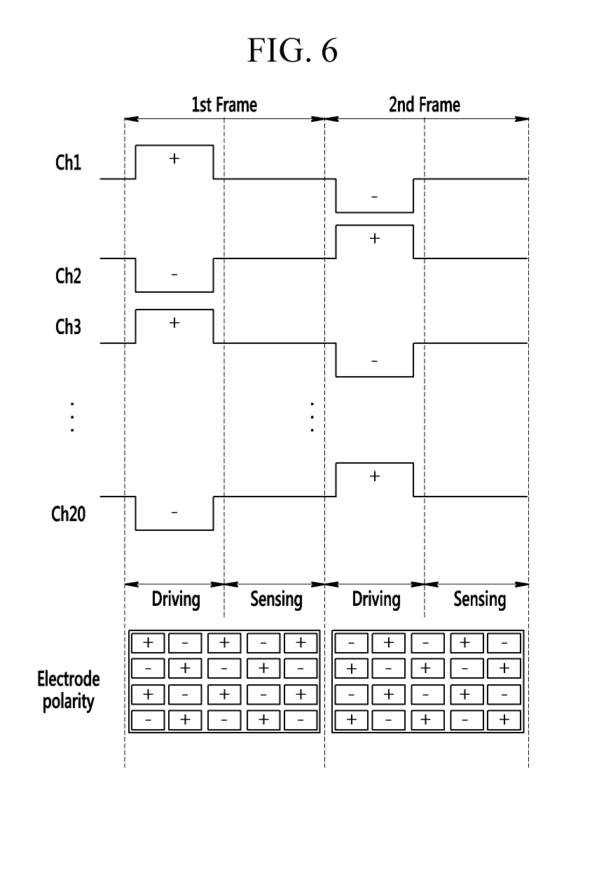

FIG. 6 is a diagram illustrating a method for driving a touch screen panel according to another exemplary embodiment. As illustrated in FIG. 6, the touch driver 84 may output the sensing driving signal so that the sum of polarities of the sensing driving signals output to the plurality of touch electrodes 80 during one frame is substantially 0.

For example, n the first frame, the touch driver 84 may output the positive sensing driving signal to the odd-numbered touch electrodes Ch1, Ch3, Ch5, . . . , Ch19 and the negative sensing driving signal to the even-numbered touch electrodes Ch2, Ch4, Ch6, . . . , Ch20.

The touch driver 84 may output the sensing driving signal so that the sum of polarities of the sensing driving signals output to one touch electrode 80 during consecutive frames is substantially 0.

For example, in the second frame shown in FIG. 6, the touch driver 84 may output the positive sensing driving signal to the even-numbered touch electrodes Ch2, Ch4, Ch6, . . . , Ch20 and the negative sensing driving signal to the odd-numbered touch electrodes Ch1, Ch3, Ch5, . . . , Ch19.

Since the number of touch electrodes 80 to which the positive sensing driving signal is applied and the number of touch electrodes 80 to which the negative sensing driving signal is applied are the same as each other in one frame and in consecutive frames, the coupling potential of the touch driving signal and the common electrode 70 becomes substantially 0. As a result, the common voltage noise by the touch driving signal may be reduced.

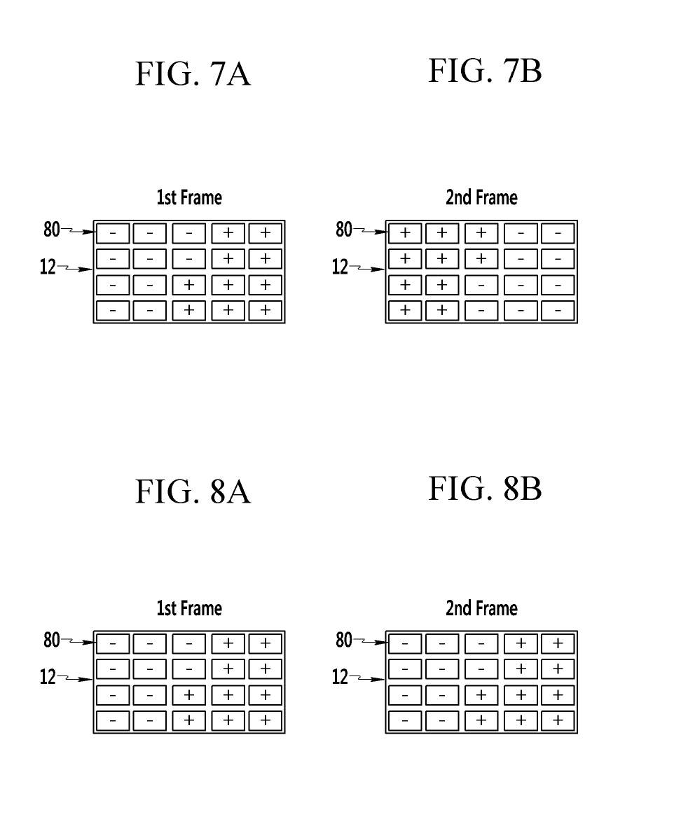

FIGS. 7A, 7B, 8A, 8B, 9A, 9B, 10A, 10B, 11A, and 11B are diagrams illustrating a method for driving a touch screen panel according to various exemplary embodiments.

As illustrated in FIGS. 7A and 7B, the touch driver 84 may output the sensing driving signal by dividing the touch region 12 into left and right regions so that substantially same number of electrodes are included in the divided regions and separately output the sensing driving signals having different polarities to the divided regions.

For example, as shown in FIG. 7A, in the first frame, the touch driver 84 may output the positive sensing driving signal to the touch electrodes 80 positioned in the right region and the negative sensing driving signal to the touch electrodes 80 positioned in the left region.

As shown in FIG. 7B, In the second frame, the touch driver 84 may output the positive sensing driving signal to the touch electrodes 80 positioned in the right region and the negative sensing driving signal to the touch electrodes 80 positioned in the left region.

Then, since the number of touch electrodes 80 to which the positive sensing driving signal is applied and the number of touch electrodes 80 to which the negative sensing driving signal is applied are the same as each other in one frame, the coupling potential of the touch driving signal and the common electrode 70 is substantially 0, and as a result, the common voltage noise by the touch driving signal may be reduced.

As illustrated in FIGS. 8A and 8B, the touch driver 84 may output the sensing driving signal by dividing the touch region 12 into the left and right regions so that the substantially same number of electrodes are included in the divided regions.

For example, as shown in FIG. 8A, in the first frame, the touch driver 84 may output the positive sensing driving signal to the touch electrodes 80 positioned in the right region and the negative sensing driving signal to the touch electrodes 80 positioned in the left region.

The touch driver 84 may output the sensing driving signal so that the sum of polarities of the sensing driving signals output to one touch electrode 80 is substantially 0 during the consecutive frames.

Thus, in the second frame shown in FIG. 8B, the touch driver 84 may output the positive sensing driving signal to the touch electrodes 80 positioned in the left region and the negative sensing driving signal to the touch electrodes 80 positioned in the right region.

Then, since the number of touch electrodes 80 to which the positive sensing driving signal is applied and the number of touch electrodes 80 to which the negative sensing driving signal is applied are the same as each other in one frame and in consecutive frames, the coupling potential of the touch driving signal and the common electrode 70 is substantially 0, and as a result, the common voltage noise by the touch driving signal may be reduced.

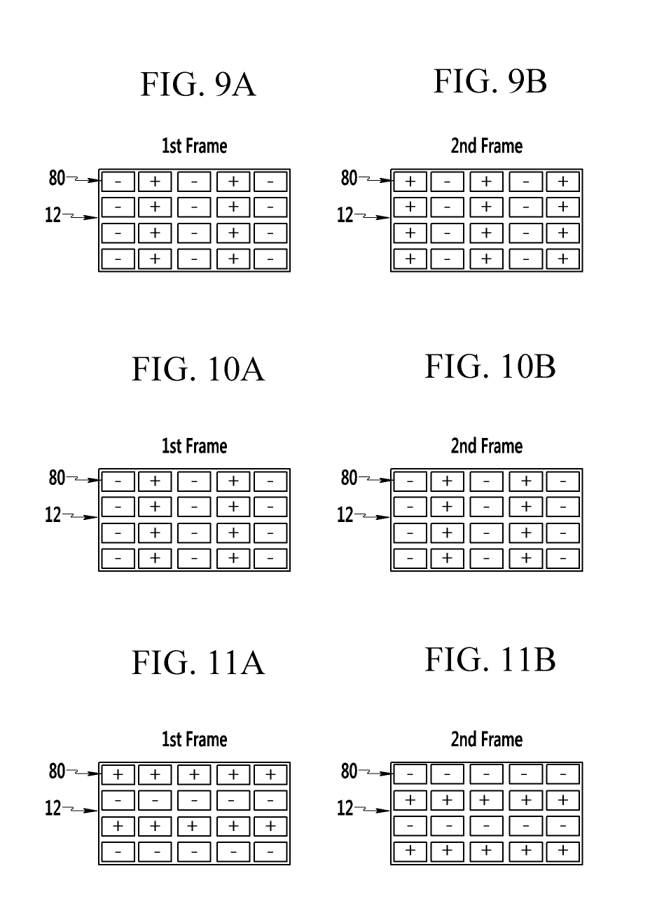

As illustrated in FIGS. 9A and 9B, the touch driver 84 may output the sensing driving signal by dividing the touch region 12 in a column direction or a row direction.

For example, in the first frame shown in FIG. 9A, the touch driver 84 may output the positive sensing driving signal to the touch electrodes 80 positioned in even-numbered columns and the negative sensing driving signal to the touch electrodes 80 positioned in odd-numbered columns.

In the second frame shown in FIG. 9B, the touch driver 84 may output the positive sensing driving signal to the touch electrodes 80 positioned in the even-numbered columns and the negative sensing driving signal to the touch electrodes 80 positioned in the odd-numbered columns.

Since the number of touch electrodes 80 to which the positive sensing driving signal is applied and the number of touch electrodes 80 to which the negative sensing driving signal is applied are substantially the same as each other in one frame, a coupling potential of the touch driving signal and the common electrode 70 is substantially 0, and as a result, the common voltage noise by the touch driving signal may be reduced.

As illustrated in FIGS. 10A and 10B, the touch driver 84 may output the sensing driving signal by dividing the touch region 12 in the column direction.

For example, in the first frame shown in FIG. 10A, the touch driver 84 may output the positive sensing driving signal to the touch electrodes 80 positioned in the even-numbered columns and the negative sensing driving signal to the touch electrodes 80 positioned in the odd-numbered columns.

The touch driver 84 may also output the sensing driving signal so that the sum of polarities of the sensing driving signals output to one touch electrode 80 during the consecutive frames is substantially 0.

In the second frame shown in FIG. 10B, the touch driver 84 may output the positive sensing driving signal to the touch electrodes 80 positioned in the odd-numbered columns and the negative sensing driving signal to the touch electrodes 80 positioned in the even-numbered columns.

Since the number of touch electrodes 80 to which the positive sensing driving signal is applied and the number of touch electrodes 80 to which the negative sensing driving signal is applied are the same as each other in one frame and in consecutive frames, the coupling potential of the touch driving signal and the common electrode 70 is substantially 0, and as a result, the common voltage noise by the touch driving signal may be reduced.

As illustrated in FIGS. 11A and 11B, the touch driver 84 may output the sensing driving signal by dividing the touch region 12 in the row direction.

For example, in the first frame shown in FIG. 11A, the touch driver 84 may output the positive sensing driving signal to the touch electrodes 80 positioned in the even-numbered rows and the negative sensing driving signal to the touch electrodes 80 positioned in the odd-numbered rows.

The touch driver 84 may also output the sensing driving signal so that the sum of polarities of the sensing driving signals output to one touch electrode 80 during the consecutive frames is substantially 0.

In the second frame shown in FIG. 10B, the touch driver 84 may output the positive sensing driving signal to the touch electrodes 80 positioned in the odd-numbered rows and the negative sensing driving signal to the touch electrodes 80 positioned in the even-numbered rows.

Since the number of touch electrodes 80 to which the positive sensing driving signal is applied and the number of touch electrodes 80 to which the negative sensing driving signal is applied are the same as each other in one frame and in consecutive frames, the coupling potential of the touch driving signal and the common electrode 70 is substantially 0, and as a result, the common voltage noise by the touch driving signal may be reduced.

According to the exemplary embodiments, it image quality error and deterioration of touch sensitivity may be prevented.

The aforementioned present invention may be implemented as a computer readable code in a medium in which a program is recorded. A computer readable medium may include all kinds of recording devices in which data that may be read by a computer system are stored. An example of the computer readable medium may include a hard disk drive (HDD), a solid state disk (SSD), a silicon disk drive (SDD, a read only memory (ROM), a random access memory (RAM), a compact disk read only memory (CD-ROM), a magnetic tape, a floppy disk, an optical data storage device, and the like, and also include a medium implemented in a form of a carrier wave (for example, transmission through the Internet). The computer may include the timing controller 6 or the touch driver 84 of the display device.

Indeed, in exemplary embodiments, the touch driver, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the touch driver, and/or one or more components thereof may include or otherwise be associated with one or more memories (not shown) including code (e.g., instructions) configured to cause the touch driver, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A touch screen panel, comprising:
touch electrodes disposed in a matrix pattern on a display panel, the display panel comprising pixels and the pixels comprising a common electrode to which a common voltage is configured to be supplied; and
a touch driver electrically connected to touch electrodes and configured to apply sensing driving signals having different polarities to each of the touch electrodes.

2. The touch screen panel of claim 1, wherein:
the touch electrodes are divided into groups of touch electrodes, each group of touch electrodes configured to receive sensing driving signals having different polarities.

3. The touch screen panel of claim 2, wherein:
the touch driver is configured to apply the sensing driving signals having different polarities to adjacent touch electrodes, respectively.

4. The touch screen panel of claim 2, wherein:
the groups of touch electrodes comprise:
a first group of touch electrodes disposed in first columns; and
a second group of touch electrodes disposed in second columns, each first column and second column disposed alternating with each other.

5. The touch screen panel of claim 1, wherein:
the number of first touch electrodes to which a positive sensing driving signal is applied and the number of second touch electrodes to which a negative sensing driving signal is applied are the same as each other during a frame.

6. The touch screen panel of claim 5, wherein:
the touch driver is configured to apply the negative sensing driving signal to the first touch electrodes and the positive sensing driving signal to the second touch electrodes, during the frame.

7. The touch screen panel of claim 5, wherein:
the touch driver is configured to apply the sensing driving signal to the touch electrodes and is configured to receive sensing output signals output from the touch electrodes, during the frame.

8. The touch screen panel of claim 7, wherein:
the touch electrodes are configured to form a self-sensing capacitor with an external object, the self-sensing capacitor configured to be charged with a charge amount based on the sensing driving signal.

9. The touch screen panel of claim 1, wherein:
the touch driver is configured to simultaneously apply the sensing driving signal to the touch electrodes.

10. The touch screen panel of claim 6, wherein:
the touch driver is configured to apply the positive sensing driving signal to the first touch electrodes and the negative sensing driving signal to the second touch electrodes, during a subsequent frame.

11. A method for driving a touch screen panel, comprising:
disposing touch electrodes in a matrix pattern on a display panel, the display panel comprising:
pixels comprising a common electrode to which a common voltage is supplied; and
a touch driver electrically connected to touch electrodes;
applying, by the touch driver, sensing driving signals having different polarities to each of the touch electrodes; and
receiving, by the touch driver, sensing output signals output from the touch electrodes during one frame.

12. The method of claim 11, wherein:
applying of the sensing driving signals comprises: dividing the touch electrodes receiving the sensing driving signals into groups of touch electrodes, each group of touch electrodes receiving sensing driving signals having different polarities.

13. The method of claim 12, wherein:
the groups of touch electrodes comprise:
a first group of touch electrodes disposed in first columns; and
a second group of touch electrodes disposed in second columns, each first column and second column disposed alternating with each other.

14. The method of claim 12, wherein:
the groups of touch electrodes comprise:
a first group of touch electrodes disposed in first rows; and
a second group of touch electrodes disposed in second rows, each first row and second row disposed alternating with each other.

15. The method of claim 11, wherein:
the number of first touch electrodes to which a positive sensing driving signal is applied and the number of second touch electrodes to which a negative sensing driving signal is applied are the same as each other during a frame.

16. The method of claim 15, further comprising:
applying the negative sensing driving signal to the first touch electrodes and the positive sensing driving signal to the second touch electrodes, during the frame.

17. The method of claim 11, wherein:
applying of the sensing driving signals comprises simultaneously applying the sensing driving signal to the touch electrodes.

18. The method of claim 15, further comprising:
applying the positive sensing driving signal to the first touch electrodes and the negative sensing driving signal to the second touch electrodes, during a subsequent frame.
